(19) United States
(12) Patent Application Publication
(10) Pub. No.: US 2010/0110825 A1
(43) Pub. Date: May 6, 2010

(54) Mixer for desedimentation of the precipitate in vats for containing at least one suspension for agricultural use

(75) Inventors: Stefano Puglia, Scandiano (IT); Marco Vernia, Rubiera (IT)

Correspondence Address: MODIANO & ASSOCIATI, Via Merarigli, 16, MILANO, 20123, IT

(73) Assignee: ARAG S.R.L.

(21) Appl. No.: 12/588,896

(22) Filed: Nov. 2, 2009

(30) Foreign Application Priority Data
Nov. 5, 2008 (IT) MO2008A000280

(51) Int. Cl. B01F 15/00; B01F 15/02

(52) U.S. Cl. 366/138

(57) ABSTRACT

A mixer for desedimentation of the precipitate in a containment vat of at least one suspension for agricultural use, which comprises dispenser for at least one pressurized fluid for washing the bottom of the vat to lift and disperse the precipitate. The dispensers comprise a first plurality of nozzles which generate concentrated jets of washing fluid which are mutually separate and at least directed toward the vat bottom. Spacers are provided for spacing the dispensers from the vat bottom, that are jointly associatable inside the vat proximate to the bottom. The dispensers comprise a box-shaped body, internally hollow, and provided with at least one inlet for washing fluid, connected with an inflow for introducing the washing fluid under pressure. A plurality of first seats are arranged at least on the lower wall of the body that is directed toward the bottom for accommodating at least the first plurality of nozzles. Concentrated jets from the nozzles mutually diverging so that each one dispenses washing fluid under pressure at least toward a specific region of the vat bottom to lift sediment therefrom.

The present invention relates to a mixer for desedimentation of the precipitate in vats for containing at least one suspension for agricultural use.

### BACKGROUND OF THE INVENTION

It is known that the correct agitation of a mixture or a suspension, for example, for plant treatments or the like, in a containment vat, a tank of spraying machines and the like, is one of the most critical aspects in the step for use of these suspensions and/or mixtures for agricultural use.

This critical aspect becomes more evident if it is necessary to subject to restrictive certifications newly built spraying machines or subject to certified testing spraying machines that are already in use.

In particular, it is known that prolonged nonuse, even for just a few hours of inactivity of the spraying machine, causes the particles, which should remain suspended in the vehicle, for example water, to sediment on the bottom of the containment vat and therefore to be no longer available for drawing by the spraying machine and for distribution when activity resumes.

For example, this problem is more severely felt in spraying machines used for plant treatments, for example for fruit-bearing plants or for vines. The use of copper oxychloride is in fact often provided for these crops; due to its particular physical characteristics, it tends to precipitate easily in static conditions of the suspension and is particularly difficult to keep in suspension.

Mixers for spraying machines are known which use part of the liquid pressurized by the spraying pump to supply hydraulic agitators and other agitation systems which use only the return flow of the pressure regulator or systems obtained by combining these two solutions.

These mixers for desedimentation of the precipitate in vats for containing at least one suspension for agricultural use are not free from drawbacks, which include the fact that they are difficult to install in the containment vat and in any case do not ensure adequate agitation of the solution/suspension, leaving unused a large fraction of the active ingredient that has sedimented on the bottom of the vat.

Moreover, inadequate agitation of the plant treatment mixture inside the containment vat or tank of the spraying machine entails considerable disadvantages on the treatment to be performed, including:

uneven distributions of the treatment product on the target for which it is intended;

possible blockages of filters and nozzles for dispensing the treatment;

difficulty in washing the tank of the spraying machine once work has ended, for example, in order to make it available for different treatments and the like;

potentially, the use of treatments that have non-optimum mixing can entail environmental damage and/or plant toxicity phenomena besides reducing considerably the effectiveness of the treatment that is dispensed.

### SUMMARY OF THE INVENTION

The aim of the present invention is to eliminate the above-mentioned drawbacks of the background art, by providing a mixer for desedimentation of the precipitate in containment vats of at least one suspension for agricultural use which allows uniform and effective mixing of the precipitate, reduces the waste of active ingredient and at the same time ensures high efficiency of use of the suspension.

Within this aim, an object of the invention is to ensure quick, repeatable and optimizable installation of the mixer in containment vats which takes into account the geometric variables of the vat itself and the physical properties of the precipitate.

Another object of the present invention is to provide a mixer that is simple, relatively easy to provide in practice, safe in use, effective in operation and of relatively low cost.

This aim and these and other objects which will become better apparent hereinafter are achieved by the present mixer for desedimentation of the precipitate in containment vats of at least one suspension for agricultural use, which comprises means for dispensing at least one pressurized fluid for washing the bottom of a containment vat to lift and disperse the precipitate, said dispensing means comprising a first plurality of nozzles which generate concentrated jets of said dispensed washing fluid which are mutually separate and at least directed toward said bottom, characterized in that it comprises means for spacing said dispensing means from said bottom, which are adapted to be jointly associated inside said vat proximate to said bottom, said dispensing means comprising a box-like body which is internally hollow and provided with at least one inlet for said washing fluid, which can be associated with means for introducing said washing fluid under pressure, comprising a plurality of first seats for accommodating at least said first plurality of said nozzles arranged at least on the lower wall of said box-like body that is directed toward said bottom, the concentrated jets of said nozzles mutually diverging so that each one dispenses said washing fluid under pressure at least toward a specific region of said bottom and so that the sediment is lifted from said region.

### BRIEF DESCRIPTION OF THE DRAWINGS

Further characteristics and advantages of the present invention will become better apparent from the following detailed description of a preferred but not exclusive embodiment of a mixer for desedimentation of the precipitate in containment vats of at least one suspension for agricultural use, illustrated by way of nonlimiting example in the accompanying drawings, wherein:

FIG. 1 is a perspective exploded view of a mixer according to the invention;

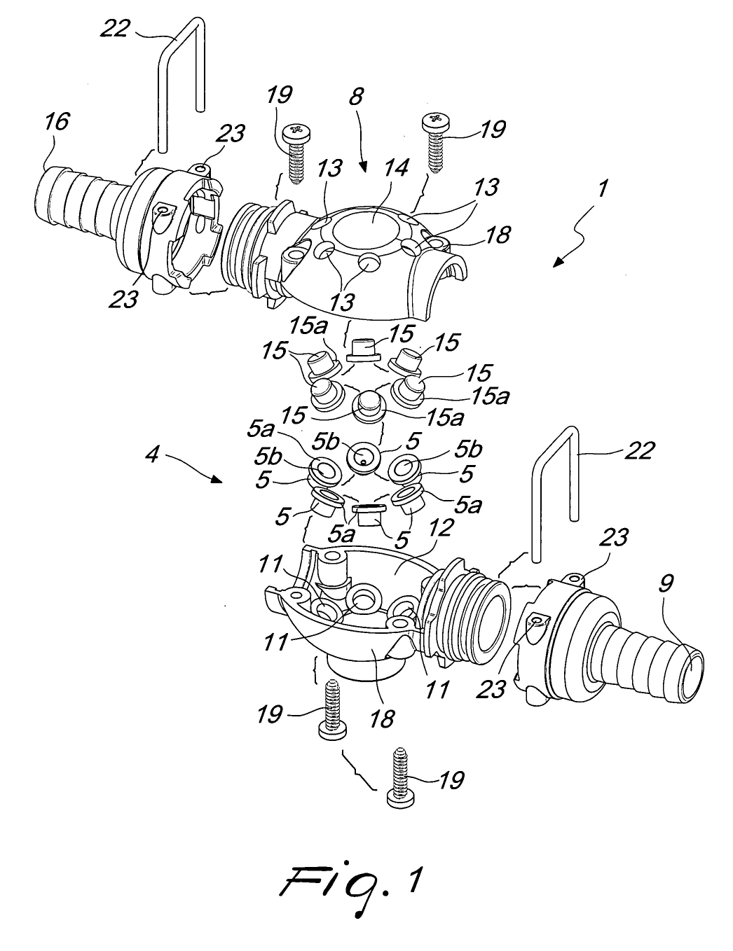

FIG. 2 is a perspective view of the mixer according to the invention, during a work step;

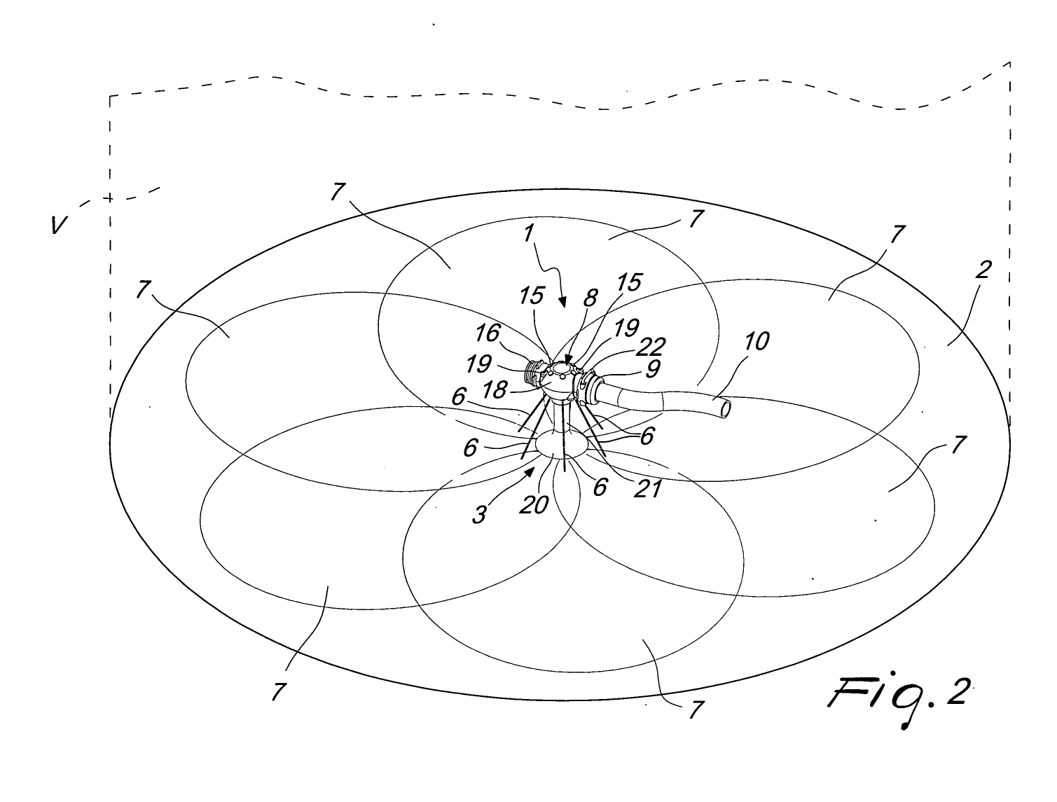

FIG. 3 is a top view of the mixer shown in FIG. 2.

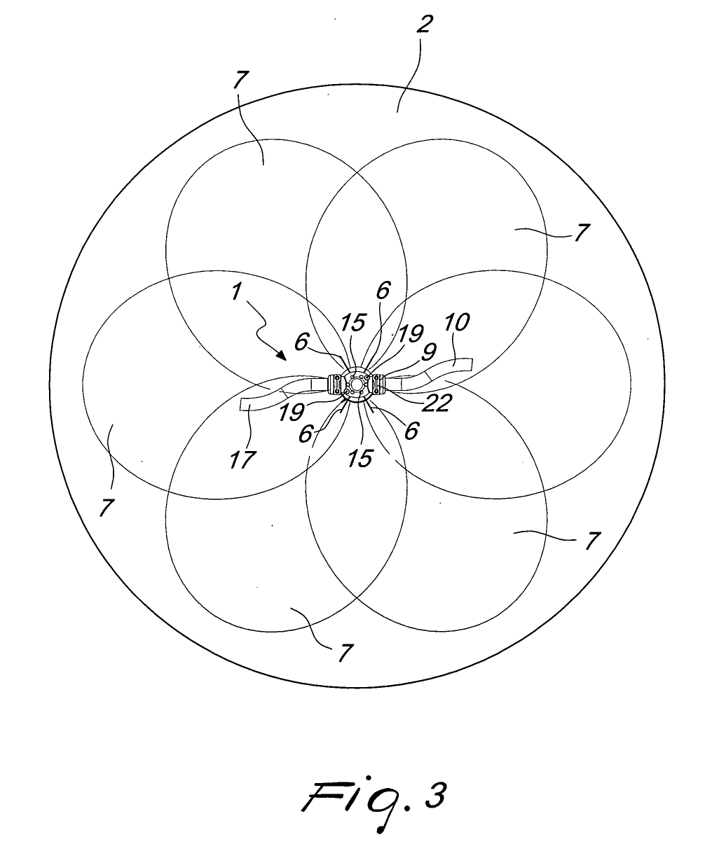

### DESCRIPTION OF THE PREFERRED EMBODIMENTS

With reference to the figures, the reference numeral 1 generally designates a mixer, mountable in containment vats for desedimentation of the precipitate in the containment vats containing at least one suspension and/or solution for agricultural use.

The mixer 1 comprises means for dispensing at least one pressurized fluid for washing the bottom 2 of the containment vat V in order to lift and disperse the precipitate in the solution and/or suspension.

Preferably, the same liquid that is present in the containment vat V is used as washing liquid; in this manner it is possible to avoid altering the concentration of the solution and/or suspension contained in the vat.

In particular, the mixer 1 comprises means 3 for spacing the dispensing means from the bottom 2.

The spacer means 3 are adapted to be associated jointly inside the containment vat V proximate to such bottom.

For example, the spacer means are jointly associated with the bottom 2.

The dispensing means comprise a first plurality 4 of nozzles 5, which generate concentrated jets 6 of the dispensed washing fluid which are mutually separate and are at least directed toward the bottom 2.

In particular, each one of the first plurality 4 of nozzles 5 dispenses the pressurized washing fluid at least toward a specific region 7 of said bottom in order to lift the sediment from such region.

In particular, each nozzle 5 dispenses toward a region 7 that is substantially separate from the region 7 affected by another nozzle 5.

Advantageously, the washing fluid is dispensed at a pressure comprised between 2 and 15 bar.

In particular, the fluid is dispensed at a pressure of substantially 10 bar.

The dispensing means further comprise at least one box-like body 8, which is hollow internally and is provided with at least one inlet 9 for the washing fluid, which can be associated with inflow means 10 for introducing the washing fluid under pressure.

The inflow means 10 are, for example, of the type of a flexible hose that can be associated with a pump or the like for introducing the pressurized washing fluid.

The box-like body 8 comprises a plurality of first seats 11 for accommodating removably at least the first plurality 4 of nozzles 5 arranged at least on the lower wall 12 of the box-like body 8 that is directed toward the bottom 2.

Advantageously, the concentrated jets 6 of the nozzles 5 mutually diverge.

Each nozzle 5 of the first plurality 4 generates concentrated jets 6, which are inclined with respect to the direction that is substantially perpendicular to the bottom 2 or, equivalently, to the substantially vertical direction.

The nozzles 5 of the first plurality 4 generate, in particular, concentrated jets 6 which are inclined, with respect to the direction that is substantially perpendicular to the bottom 2, at angles that are substantially mutually identical.

For example, the concentrated jets 6 of the nozzles 5 diverge with respect to a substantially vertical direction by an angle that is substantially comprised between 15° and 45°, and in particular are inclined at 30°.

In this case, the region 7 is substantially elliptical, the ratio between the minor axis and the major axis of such ellipse decreasing as the inclination of the jet 6 with respect to the substantially vertical direction increases.

Moreover, each nozzle 5 might further be inclined at an angle other than the vertical.

However, different configurations of the mixer 1 and in particular of the dispensing means are not excluded in which for example the nozzles 5 and therefore the concentrated jets 6 of washing liquid are mutually parallel and substantially perpendicular to the plane formed by the bottom and/or substantially vertical.

In this case, the region 7 has a substantially circular shape.

The box-like body 8 comprises a plurality of second seats 13 for accommodating at least one second plurality of nozzles 5, which are arranged at least on the upper wall 14 of the box-like body 8 that lies opposite the lower wall 12 that is directed toward the bottom 2.

The second plurality of nozzles 5 dispenses the washing fluid in the opposite direction with respect to the dispensing direction toward the bottom 2, and therefore toward the top of the containment vat in order to mix inside said vat the sediment lifted from the bottom by the first plurality 4 of nozzles 5.

Each nozzle 5 of the second plurality generates concentrated jets which are inclined with respect to the direction that is substantially perpendicular to the bottom 2 or, equivalently, to the substantially vertical direction.

The nozzles 5 of the second plurality generate, in particular, concentrated jets which are inclined with respect to the direction that is substantially perpendicular to the bottom 2 by angles which are substantially mutually identical, for example by an angle comprised between 15° and 45° and advantageously 30°.

The mixer 1 further comprises a plurality of plugs 15 for the first seats 11 and/or the second seats 13, which can be accommodated in one or more of such seats as an alternative to the nozzles 5, in order to interrupt the dispensing of the pressurized liquid in the corresponding region 7 and/or upper region toward the top of the containment vat.

Each plug 15 is adapted to close the respective first and/or second seat, respectively 11 and/or 13, with which it is associated, and therefore to interrupt the dispensing of the washing fluid in the specific region 7 and/or in the upper mixing region for which the concentrated jet 6 would be intended if at least one second seat 13 were occupied by a nozzle 5.

In particular, the nozzles 5 and/or the plugs 15 are inserted by pressing and interlocking in the first and/or second seats, respectively 11 and/or 13.

Each nozzle 5 and/or plug 15 has at least one wall, respectively 5a and/or 15a, for abutment in the corresponding first seat 11 or second seat 13 in which it is inserted for axial locking at least along the dispensing direction of said nozzle.

Advantageously, the first seats 11 and/or the second seats 13 are arranged so as to be mutually equidistant on a circumference.

In a particular embodiment shown in the figures, the mixer 1 comprises six nozzles 5 arranged in six first seats 11 and six plugs 15 arranged in six second seats 13.

However, different configurations of the mixer 1, formed by any combination of nozzles 5 and/or plugs 15 accommodated in the first seats 11 and/or in the second seats 13, for example studied on the basis of the shape of the vat and/or of the bottom thereof, are not excluded.

Moreover, the box-like body can comprise any number of first seats 11 and second seats 13 and respective nozzles 5 and/or plugs 15 to vary the dispensing pattern according to the shape of the containment tank.

Further, the box-like body 8 comprises at least one outlet 16 for the pressurized fluid, which can be associated with outflow means 17 for the outflow of the pressurized liquid.

For example, the outlet 16 is suitable for series hydraulic connection of a plurality of mixers 1.

If a configuration of several mixers 1 connected hydraulically to each other in series is not necessary, the mixer 1 comprises at least one means for temporary closure of the outlet, such as a cap or the like, which is not shown in the figures because it is of a known type.

The box-like body 8 is, for example, provided by joining two shells 18, for example by way of threaded elements 19, which are made of at least one plastic material, for example of the type of polypropylene or polyamide.

Each nozzle 5 is made of at least one ceramic material with high resistance to abrasion.

Moreover, each nozzle 5 has an internal surface 5b that is substantially frustum-shaped in order to concentrate the jet 6 of the washing liquid.

Advantageously, the nozzles 5 have holes for the outflow of the washing fluid with a diameter comprised substantially between 1 and 3 mm.

The spacer means 3 comprise at least one base 20, which can be jointly associated with the bottom 2 in order to support a stem 21, which is associated with the dispensing means and in particular with the box-like body 8.

Moreover, the spacer means 3 comprise means for adjusting the height, with respect to the bottom 2, at least of the dispensing means and therefore of the nozzles.

The adjustment means comprise, for example, threaded elements for fixing the mutual position, which are interposed between the stem 21, the base 20 and/or the box-like body 8 or the like.

In particular, the spacer means 3 are such as to keep the first plurality 4 of nozzles 5 at a height with respect to the bottom 2 that is comprised between 25 and 150 mm.

Advantageously, the spacer means 3 keep the first plurality 4 of nozzles 5 at a preferred but not exclusive height, with respect to the bottom 2, of 75 mm.

It is further possible to connect several mixers 1 to provide a mixing assembly for desedimentation of the precipitate in vats for the containment of at least one suspension for agricultural use.

In particular, the assembly comprises at least one pair of mixers 1 as described above, which are mutually connected hydraulically.

Advantageously, the pair of mixers 1 is connected hydraulically in series.

In particular, the assembly comprises the inflow means 10 for introducing the washing fluid, which are associated with the inlet 9 of each one of the mixers 1 of the pair, and the outflow means 17, which are associated with at least the outlet 16 of the first mixer 1.

The means 17 for outflow from the first mixer 1 coincide with or are the same as the inflow means 10 for introducing the washing fluid into the second one of the mixers 1 for the inflow of the pressurized washing fluid that exits from the first mixer 1 into the second mixer 1.

The inflow means 10 and the outflow means 17 are for example both of the type of a flexible hose.

The assembly can have a variable plurality of mixers 1 which are mutually connected hydraulically in series and/or in parallel.

The mixer 1 further comprises means for detachable anchoring of the inflow means 10 and/or of the outflow means 17 to the inlet 9 and/or to the outlet 16.

The anchoring means, for example, are of the type of fork-like couplings 22, which can be inserted in holes 23 for removable retention of the inflow means 10 and/or of the outflow means 17 at the inlet 9 and/or at the outlet 16 of the box-like body 8.

Advantageously, the mixer 1 is provided in a mixing kit, which is composed of at least one mixer 1 as described, which has a plurality of nozzles 5 and plugs 15 which are mutually interchangeable and can be arranged so as to be able to configure the dispensing of the washing liquid according to the specific shape of the containment vat.

The terms “substantial” or “substantially” are intended to mean that the features to which they refer are as indicated but for deviations or differences that are within tolerances that are known to be usual in the field by those skilled in the art.

In practice it has been found that the described invention achieves the proposed aim and objects and in particular the fact is stressed that the mixer for desedimentation of the precipitate in vats for the containment of at least one suspension for agricultural use allows a uniform and effective mixing of the precipitate, at the same time reduces the waste of active ingredient and ensures a high efficiency of use of the suspension/solution.

Moreover, the device according to the invention ensures quick, repeatable and optimizable installation of the mixer in containment vats which takes into account the geometric variables of the vat itself and the physical properties of the precipitate.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Patent Application No. MO2008A000280 from which this application claims priority are incorporated herein by reference.

What is claimed is:

1. A mixer mountable in a containment vat containing at least one suspension for agricultural use for desedimentation of a precipitate forming sediment at the bottom of the containment vat, the mixer comprising: dispensing means for dispensing at least one pressurized fluid for washing the bottom of the containment vat so as to lift and disperse the precipitate, said dispensing means comprising a first plurality of nozzles generating concentrated fluid jets which are mutually separate and are directed at least toward the bottom of the vat; spacer means for spacing, upon mounting of the mixer in the vat, said dispensing means from the bottom at the vat, said spacing means being adapted to be jointly associated inside the vat proximate to the bottom thereof; wherein said dispensing means comprise a box-shaped body which is internally hollow and provided with at least one inlet for the washing fluid, said inlet being associatable with inflow means for introducing the washing fluid under pressure, and wherein said box-shaped body comprises a plurality of first seats that accommodate at least said first plurality of nozzles arranged at least on a lower wall of said box-shaped body, said lower wall being directed toward the bottom of the vat, the concentrated fluid jets of said nozzles being generated mutually diverging so that each jet dispenses the washing fluid under pressure at least toward a specific region of the bottom of the vat, whereby the sediment is lifted from said specific region.

2. The mixer of claim 1, wherein said dispensing means comprise at least one second plurality of nozzles, said box-shaped body comprising a plurality of second seats for accommodating said at least one second plurality of nozzles arranged at least on an upper wall of said box-shaped body that lies opposite said lower wall thereof directed toward the bottom of the vat, said at least one second plurality of nozzles dispensing washing fluid toward a top region of the containment vat in order to mix in the vat the sediment lifted by said first plurality of nozzles.

3. The mixer of claim 2, wherein said first seats and/or said second seats are located mutually equidistant on a circumference.

4. The mixer of claim 2, wherein each one of said nozzles of said first plurality and/or said at least one second plurality of nozzles generate is adapted to concentrate jets which are inclined with respect to a direction that is substantially perpendicular to the bottom of the vat.

5. The mixer of claim 2, wherein said nozzles of said first plurality and/or of said at least one second plurality of nozzles are adapted to generate concentrated jets which are inclined with respect to a direction that is substantially perpendicular to the bottom of the vat by angles which are substantially mutually identical.

6. The mixer of claim 2 comprising a plurality of plugs, which can be accommodated in said first seats and/or in said second seats as an alternative to said nozzles so as to interrupt dispensing of pressurized liquid in said specific region and/or top region of said containment vat.

7. The mixer of claim 2, wherein said box-shaped body comprises at least one outlet for the pressurized fluid, which can be associated with outflow means for outflow of the pressurized liquid.

8. The mixer of claim 1, wherein said spacer means comprise: at least one base, which is adapted to be jointly associated with the bottom of the vat; and a stem which is associated with said dispensing means and is supported on the spacer means.

9. The mixer of claim 1, comprising adjusting means for adjusting a height with respect to the bottom of the vat of at least said dispensing means.

10. A mixing assembly mountable in a containment vat containing at least one suspension for agricultural use for the desedimentation of a precipitate forming sediment at the bottom of the containment vat, which comprises at least one pair of mixers as set forth in claim 1, the pair of said mixers being mutually connected hydraulically.

11. The assembly of claim 10, comprising: inflow means for introducing fluid which are associated with the inlet of each one of said mixers of said at least one pair; and outflow means which are associated at least with the outlet of a first one of the mixers, said outflow means coinciding with the inflow means for introducing washing fluid to a second one of the mixers for inflow of pressurized fluid that exits from the first mixer in the second mixer, said mixers being mutually connected in series.
